(19) United States
(12) Patent Application Publication
(10) Pub. No.: US 2004/0199454 A1
(43) Pub. Date: Oct. 7, 2004

(54) Dynamic advance purchase admission to a venue

(76) Inventors: Michael G. Jungen, Orlando, FL (US); Michael K. Foley, Orlando, FL (US); Steven K. Brown, Anaheim, CA (US)

Correspondence Address: Greenberg Traurig, LLP, Suite 400, 2450 Colorado Avenue, Santa Monica, CA, 90404, US

(21) Appl. No.: 10/754,811

(22) Filed: Jan. 8, 2004

Related U.S. Application Data
(60) Provisional application No. 60/438,885, filed on Jan. 8, 2003.

(51) Int. Cl. G06F 17/60

(52) U.S. Cl. 705/37

(57) ABSTRACT

A dynamic advance purchase admission system to a venue is disclosed by providing a computer programmable media, such as a card, readable by a card reader. Identifying characters are provided on the media and activated at a location remote from the venue to provide access to the venue when read at the venue.

### RELATED APPLICATION

This application claims priority to provisional application Serial No. 60/438,885, filed on Jan. 8, 2003, entitled “Dynamic Advance Purchase Admission to a Venue.” The contents of this provisional application are incorporated herein by reference.

### BACKGROUND OF THE INVENTION

1. Field of the Invention

The present invention relates generally to pre-paid admission to a venue.

2. Related Art

Venues requiring admission traditionally employ a number of ticket booths at or near an entrance which allow visitors to purchase admission to the venue. The purchase of admission is traditionally at the venue, just prior to entrance. For example, at a theme park, there are generally several ticket booths that offer admission tickets for sale at the park entrance. At a movie theater, there are also ticket booths at the entrance to the theater where guests purchase movie tickets prior to the movie. Resorts offering sports such as skiing or snowboarding also utilize ticket booths for selling lift tickets or passes to the mountain.

These methods of selling admission have certain drawbacks. For example, the lines can often become quite long at such ticket booths. Visitors may become reluctant to visit the park if they know they may need to stand in a long line. Utilizing ticket booths also requires that an employee be present to sell admission, which can be costly.

Attempts have been made to offer tickets to venues for sale at retail locations. In this case, the retail store purchases tickets from the venue. The tickets have a predetermined monetary value and are handled in the same fashion as any other piece of merchandise. Once in the stores, the tickets are secured, sold, replenished, and accounted for. All these activities are quite costly. The pre-purchase of tickets also places a cash flow burden on the store.

When the venue experiences a price increase, the retail stores are required to receive new ticket inventory valued at the new price. The inventory exchange can result in a loss of sales when the ticket product at the new price has yet to arrive at the individual stores. The accounting to maintain the inventory, sales, and commission of tickets at a retail location can be complicated. The prepaid inventory is reflected on retailer's balance sheet and has a negative impact on the retailer's economic profit.

Various methods have been suggested over the years to provide some sort of validated entry into a venue. Many such systems use prepaid cards or the like where the card's monetary value has been preset and the card is activated. Thus, such a method is not accommodating to venues where the monetary value may change periodically. In one such system, authorized subscribers to an event are first registered at a location remote from the venue. There is a need for a system which allows any user to approach a location remote from a venue without need to pre-register and quickly and easily gain authorized admission to the venue. A benefit is also that entitlements may change i.e., a one day ticket that was usable at certain venues can be changed in the back end database so that it can now valid at other or additional venues.

Therefore, a new method of offering admission tickets to a venue is desired whereby the guest does not need to wait in long lines at the venue, and can purchase admission at locations other than the venue itself and prior to the date of admission, while also eliminating the requirement that the retailer maintain a full inventory of monetary valued ticket products. Such venues may include a theme park, a theater, for movies or plays, a stadium a convention or any ticketed event.

### SUMMARY OF THE INVENTION

An object of the present invention is therefore to offer dynamic advance purchase admission to a venue for sale at locations other than the venue itself.

The present invention is a method of offering admission to a venue at locations other than through ticket booths at or near the venue. Admission cards or other media are offered at stores and can be redeemed at a later date for entry into the venue. The tickets are sold as goods, having no monetary value, therefore removing the inventory burdens of ticket sales from the ticket seller as mentioned above. The venue may be, for example, a theme park or a movie theater. The card may represent the value of one (or more) admission(s), or can also act as a type of gift certificate for a pre-determined ticket entitlement or otherwise determined by the customer.

Each card preferably has a unique identification means such as a number stored or imprinted on it. A monetary value admission and/or entitlement can be associated with the card in a database. Alternatively, the monetary value can be directly programmed into the card's memory, and be easily adjusted. The dynamic advance purchase admission cards may be similar to a credit card. The admission card preferably has a magnetic stripe which allows the card to be read and its monetary value adjusted as is appropriate. In alternative embodiments, a barcode or imprinted information may be used to give the card its identity. Infrared LED's could also be used to transmit an identifying code. Electromagnetic frequencies such as light, sound, radio waves, magnetic fields, etc. can be used to transmit an identifying code and give a card its identity. The size and shape, as well as the material from which the dynamic advance purchase admission card is formed may vary and depend upon its application.

The cards may be redeemable for admission after they have been activated at a point of sale such as a cash register. This way, the cards are worthless if stolen or shoplifted. When the card is purchased at the point of sale, the identification means, which may for example be a number, is used to update the database record and thereby activated for use. As mentioned above, the database may also contain information indicative of the monetary value the card represents. The value may be in terms of dollars, number or types of admissions, days, etc. In certain embodiments, when the card is used, its monetary value may be adjusted appropriately by updating a database field. For example, a pre-paid admission card may be purchased with the value of three single day admissions, and its monetary value be adjusted each time a one-day admission is used.

The card's monetary value could alternatively be stored on the card itself and read from a machine directly. In the case of a magnetic strip, information can be stored on the strip and easily read with a proper card reading device, or point of sale terminal. The monetary value of the card could then be adjusted by the point of sale machine directly, and there is no need to connect to a remote database to adjust the card's monetary value.

The card is also preferably packaged with a special hangar or package such that it is easily visible to customers. Cards may have indicia and physical attributes such as different text, colors, graphics, size, shape and programmable objects associated with the type or value of the card. The dynamic advance purchase admission card is preferably the actual card, or ticket, that the customer will insert into a turnstile, or similar device, at the venue. This way, guests do not need to do anything between purchase and admission to the venue. The venue preferably employs turnstiles or machines capable of reading the admission card. The turnstile or machine is in communication with a database of registered cards and grants admission based upon a registered card of the proper type or monetary or other value, such as a gift admission.

In an exemplary embodiment of the present invention, each admission card is a physical item that, as mentioned above, may have different text, colors, graphics, size, shape and programmable objects which correspond with the entitlement type, monetary value, or use restrictions of the admission entitlement represented in the database and linked to the individual card by its unique identification number. Whereas each individual card has a unique identifier, there may be many physical items of identical text, colors, graphics, size, shape or programmable objects. This notion of a unique combination of text, colors, graphics, size, shape and programmable objects (without the identifier) of the physical item can be represented by a item type identifier. The item type identifier can be stored on the card, in the database, or both. Use of the item type identifier, or a related code, during the purchase and activation of the desired admission entitlement or value can prohibit combinations of entitlements and physical items that are not appropriate. The combinatorial rules are programmed into the system or systems that wish to test for the appropriate combinations of physical item type and desired entitlement type or value. For example, a physical item may have text stating that it represents a one day admission entitlement. However, at purchase, the operator or system may erroneously ask that the individual item be activated as a four day admission which is inconsistent with the text on the physical item. By using the item type identifier, either the sales system or the system managing the entitlement database can deny the activation based on combinatorial rules programmed in the system. Thus, the invention contemplates a method of prohibiting the sale and activation of programmable media by assigning computer programmable readable characters to the programmable media and in a database defining a unique physical item type identified by its combination of text, colors, graphics, size, shape and programmable objects. Programming combinatorial rules in an activation system, a sales system, or both indicating permitted item types that can be paired with each entitlement or value that can be purchase and activated. The combinatorial rules at time of purchase can be tested in the sales system and/or activation in the activation system by permitting or denying the sale and activation based on the test results.

The combinatorial rules may be tested in a retail Point of Sales system or in a system that manages the activation of admission entitlement of value. The combinatorial rules may use binary arithmetic on the item type identifier and a number associated with the desired entitlement to determine the outcome. Finally, combinatorial rules can use a database of records that specify combinations of item type identifiers and entitlement identifiers to determine the outcome.

It is possible that the dynamic advance purchase admission cards could be purchased in many locations such as gift shops, grocery and drug stores, vending machines in hotels or airports, or almost any other retail location. The dynamic advance purchase admission could be offered for sale by reservation agents, or included in vacation packages, offered at hotels, or by tour operators. The dynamic advance purchase admission cards could also be offered for sale over the internet.

Benefits of the present invention over more traditional admission sales include wider availability of admission which may lead to an overall increase in sales. This method may be more convenient for guests as well since they do not have to wait in long lines and they can purchase tickets at their convenience. Additionally, the present invention provides for a way of purchasing admission for others as a gift. The present invention offers additional means for guest service desk, tour operators, and other ticket selling systems to sell admissions.

The system and method of the present invention addresses many of the drawbacks of prior art methods by removing the inventory burdens of ticket sales from the ticket seller and enables treating the sellable ticket items as goods bearing no monetary value. The ticket provider furnishes tickets having no monetary value that contain coded information about the individual ticket and the physical media on which it exists. Further, because the ticket has no monetary value until upgraded during a sales transaction, having an abundant supply on hand does not adversely impact the ticket seller's balance sheet. The system and method of the present invention further offers a new avenue for advertising and marketing tickets. By providing admission tickets for sale in retail locations commonly visited by the general public, a larger group of people may be reached. The pre-paid admission tickets are likely to be purchased on impulse.

The dynamic advance purchase admission cards could be used at a plurality of venues. The admission card could be used for entry to a theme park, movie or other theatrical show, or sporting event such as basketball, baseball, or hockey game. The dynamic advance purchase admission cards could act as a lift ticket at a resort for skiing or snowboarding. The dynamic advance purchase admission card could be used for a fair or convention. The present invention has applications for just about any venue where admission is monitored.

### DESCRIPTION OF THE PREFERRED EMBODIMENT

Reference will now be made in detail to an exemplary embodiment of the present invention.

In a preferred embodiment of the invention, admission to a particular venue, such as a theme park, is accomplished by providing a programmable media, such as a card that can be electronically programmed, at any desired location, such at the venue itself. This card may be packaged so as to provide a shell or look, using various types of indicia, such as holograms, embossing, photographic imprints, etc. imbedded or otherwise placed on the card to readily appear to a customer as a card related to the venue and, possibly, also relate a multiday or multi-event visit to that venue. Such a card may be hung from a placard at the point of sale.

A computer program is used to assign computer programmable readable characters, such as letters, numbers, etc. to the media. Such characters may be keyed or otherwise related to the admission to the venue on one or more days or times. These characters are recorded in the database and used to retrieve the recorded information at the venue. This retrieved information is matched with the information recorded in the database and may be upgraded, as for example, from no value and no particular time or day, or event, to a particular monetary or admission value for one or more event entries. Prior to that activation, the media has no monetary or other value. Value as used herein is used in a broad sense of being worthless from a monetary point of view, or having a value related to the cost per day or other time period of entry into the venue at the time of activation. Also, value also refers to the entitlement of entry into the venue on one or more days or to one or more events thus allowing admission into the venue without need for waiting in lines, etc. Thus, value may mean a complementary or gift value of the media.

The characters associated with the media are registered with a record in a database which, when retrieved, can be activated at a location remote from the venue upon proper payment by the user or, in the case of a complementary or gift value of the media, upon presentation by the user of suitable identification entitling the user to a complementary or gift entry to the venue on one or more days or times. When the activated media is presented at the venue, the programmable media is read or otherwise decoded and the user is allowed entry into the venue. For example, a card reader may be located at a theme park, bypassing people waiting to purchase tickets, and the user is admitted into the park for the entitled admissions associated with the card, or coded on the card.

Thus, upon proper presentation of authorization at the point remote from the venue, which can be a monetary payment in the form of cash, a debit or credit card, a complementary pass or other complementary identification, such as a letter, a gift certificate, etc., the card or programmable media is activated.

It can be seen that the card or programmable media may be used to quickly and easily adjust the cost of entry into the venue since there is no information on the card or media until activated. This cost is in the database and may be varied there as desired. Such a database can record the number of cards or media programmed, the number of days or times programmed, etc. The venue may be a theme park which usually requires a number of days to visit, or an event or show to which a number of admissions is possible. Thus, the cost of each day or entry to an event or show is recorded in the database record associated with the media and the card reader or the like will decrement usage in a manner similar to other electronic card or media or each time it is presented at the venue.

Although a particular embodiment of the invention is disclosed, variations thereof may occur to an artisan and the scope of the invention should only be limited by the scope of the appended claims.

We claim:

1. A method of offering admission to a venue, the method comprising the steps of:
providing programmable media, the media representing admission to the venue;
assigning an identifying number to each programmable media;
offering said media representing admission to the venue for sale at a retail location;
registering the identifying number on said programmable media with an admission database upon receipt of proper payment; and
allowing admission to the venue upon presentation of the media.

2. The method of claim 1 wherein the location is a retail store.

3. The method of claim 1 wherein the location is a vending machine.

4. The method of claim 1 wherein the location is a tour operator.

5. The method of claim 1 wherein the venue is a theme park.

6. The method of claim 1 wherein the venue is a theater.

7. The method of claim 1 wherein the programmable media is a card with a magnetic stripe.

8. The method of claim 1 wherein the programmable media is a card with a barcode.

9. The method of claim 1 wherein the programmable media is a card with printed information.

10. A method of allowing admission to a venue comprising the steps of:
providing a programmable media at a location remote from the venue;
assigning computer programmable readable characters to each of said programmable media;
relating the value of admission to one or more programs offered at said venue to said characters to provide authorized admission to said one or more programs at said venue when said programmable media is activated;
registering said characters on said programmable media with a database capable of reading said characters when activated at said location remote from said venue upon proper presentation of authorization by a user; and
allowing admission into said venue with said programmable media upon reading the characters on said programmable media at said venue.

11. The method of claim 10 wherein said location is a retail store.

12. The method of claim 10 wherein said location is a vending machine.

13. The method of claim 10 wherein said location is a tour operator.

14. The method of claim 10 wherein said venue is a theme park.

15. The method of claim 10 wherein said venue is a theater.

16. The method of claim 10 wherein said venue is a stadium.

17. The method of claim 10 wherein said venue is a ticketed event.

18. The method of claim 10 wherein said venue is a convention.

19. The method of claim 10 wherein the value of admission to said venue is zero dollars.

20. The method of claim 10 wherein said programmable media includes a card with a magnetic stripe readable by a magnetic stripe card reader.

21. The method of claim 10 wherein said programmable media includes a card with a barcode readable by a barcode reader.

22. The method of claim 10 wherein said programmable media includes a card having said readable characters imprinted thereon.

23. The method of claim 10 wherein said programmable media includes a card having been programmed by electromagnetic frequencies readable by a receiver when transmitted thereto.

24. A method of allowing prepaid admission to a venue comprising the steps of:
providing a programmable media at a location remote from the venue;
assigning computer program readable characters to each of said programmable media;
relating the cost of one or more programs offered at said venue to said characters to provide prepaid admission to said one or more programs at said venue when said programmable media is activated;
registering said characters on said programmable media with a database capable of reading said characters when activated at said location remote from said venue, upon proper payment by the user for the same; and
allowing prepaid admission at said venue with said programmable media upon reading the characters on said programmable media at said venue.

25. The method of claim 24 wherein the step of relating the cost of one or more programs offered at said venue to said characters includes the step of directly programming said cost into said programmable media which cost is adjustable.

26. The method of claim 25 wherein the step of adjusting said cost is carried out by information stored in said database.

27. The method of claim 24 wherein said venue is a theme park offering multiday visits, and the steps of relating the cost of one or more programs offered at said venue includes the step of relating the cost of each day of visit to said park to said characters.

28. The method of claim 27 including the step of adjusting the cost represented by said characters each day said programmable media is activated at said park.

29. The method of claim 24 including the step of recording the value of said programmable media on said database.

30. The method of claim 29 wherein the step of recording the value includes the step of recording any or all of said total monetary value, and number of prepaid days of admission to said venue.

31. The method of claim 24 including the step of providing indicia on said programmable media indicating the venue to which the programmable media relates and the value of said programmable media.

32. The method of claim 31 wherein said programmable media includes a card.

33. The method of claim 24 wherein said programmable media has no monetary value and cannot provide admission to said venue until activation of the same.

34. The method of claim 24 wherein the sales price and payment of entitlement of admission to said venue is zero dollars.

35. The method of claim 33 wherein said programmable media is a card displayed prominently at a location remote the venue.

36. A system for offering dynamic advance purchase admission to a venue, the system comprising:
programmable media disposed displayed at a location remote from said venue representing at least one admission to the venue when activated;
activation means at said location adapted to activate said programmable media;
a database for registering the identity of the programmable, media as a valid admission after activation thereof; and
a device for reading the identity of the programmable media after activation, and checking said database to see if it is a valid admission recorded in said database, and allowing admission to said venue.

37. The system of claim 36 wherein the programmable media includes the sales price and amount of payment entitling admission to said venue.

38. The system of claim 37 wherein said sales price and payment of said entitlement is zero dollars.

39. A method of offering admission to a venue, the method comprising the steps of:
providing programmable media on a display at a sale location remote from the venue, the media representing admission to the venue;
assigning identifying means to each programmable media;
offering said media representing admission to the venue for sale at a retail location;
registering the identifying means on said programmable media with an admission database upon receipt of proper payment at the sales location; and allowing admission to the venue upon presentation of the media.

40. A method of prohibiting the sale and activation of programmable media comprising the steps of:
assigning computer programmable readable characters to said media and in a database defining a unique physical item type identified by its combination of text, colors, graphics, size, shape and programmable objects;
programming combinatorial rules in an activation system, a sales system, or both, indicating permitted item types that can be paired with each entitlement or value that can be purchased and activated;
testing the combinatorial rules at time of purchase in the sales system and/or activation in the activation system; and
permitting or denying the sale and activation based on the test results.

41. The method of claim 40 where the combinatorial rules are tested in a retail Point of Sales system.

42. The method of claim 40 where the combinatorial rules are tested in a system that manages the activation of admission entitlement or value.

43. The method of claim 40 where the combinatorial rules use binary arithmetic on the item type identifier and a number associated with the desired entitlement to determine the outcome.

44. The method of claim X where the combinatorial rules use a database of records that specify combinations of item type identifiers and entitlement identifiers to determine the outcome.
